(19) United States
(12) Patent Application Publication
(10) Pub. No.: US 2014/0010400 A1
(43) Pub. Date: Jan. 9, 2014

(54) MAGNETIC COUPLING MECHANISM FOR EARPHONE WIRES

(71) Applicant: Timothy A. Morris, Alto, MI (US)

(72) Inventor: Timothy A. Morris, Alto, MI (US)

(21) Appl. No.: 13/922,498

(22) Filed: Jun. 20, 2013

Related U.S. Application Data
(60) Provisional application No. 61/662,028, filed on Jun. 20, 2012.

(51) Int. Cl. H04R 1/10

(52) U.S. Cl. CPC H04R 1/1033
USPC 381/384

(57) ABSTRACT

An anti-tangling device for earphone or headphone cords includes headphone cords having magnetic coupling elements disposed therein along a length of the cords, wherein the magnetic coupling elements of each cord are adapted to couple the associated cords to one another.

### CROSS-REFERENCE TO RELATED APPLICATION

This application claims benefit under 35 USC §119(e) of provisional application Ser. No. 61/662,028, filed Jun. 20, 2012, entitled MAGNETIC COUPLING MECHANISM FOR EARPHONE WIRES, the entire contents of which are incorporated herein by reference.

### BACKGROUND OF THE INVENTION

The present invention relates to an anti-tangling device for earphone or headphone cords, and more specifically, to headphone cords having magnetic coupling mechanisms adapted to couple associated cords to one another.

### SUMMARY OF THE PRESENT INVENTION

One aspect of the present invention includes a headphone set having cords which comprise magnets such that the cords couple to one another in an effort to reduce entanglement of the cords. Specifically, the cords have magnets disposed within an insulating member of the cords, and thus, cords having magnets of opposite poles are attracted to one another and can couple in use.

Another aspect of the present invention comprises a coupling mechanism for use with an existing headphone set, wherein the free cords of a headphone set are disposed within cord covers which have opening channels to accommodate the free cords. The cord covers are comprised of a flexible polymeric material that further comprises magnets disposed in an insulating member.

Yet another aspect of the present invention includes a headphone set having a pair of headphone units including a left headphone unit and a right headphone unit. A first cord is operably coupled to the left headphone unit at a distal end, and further coupled to a plug member at a proximal end. A second cord is operably coupled to the right headphone unit at a distal end, and further coupled to the same plug member at a proximal end. A first magnetic coupling element is disposed along a length of the first cord, and a second magnetic coupling element is disposed along a length of the second cord. The first and second cords are operable between an engaged position and an unengaged position, wherein the first and second magnetic coupling elements comprise a magnetic attraction between one another and are adapted to magnetically couple the first and second cords along a length thereof in the engaged position.

Yet another aspect of the present invention includes a headphone set having first and second cord assemblies, wherein each cord assembly includes an outer polymeric casing. Electrical wires are disposed within the outer polymeric casing of each cord assembly, and are adapted to electrically deliver audio data to headphone units associated with each cord assembly. A first magnetic coupling element is disposed along a length of the first cord assembly, and a second magnetic coupling element is disposed along a length of the second cord assembly. The first and second magnetic coupling elements are adapted to generate a magnetic attraction between one another to magnetically couple the first and second cord assemblies through the polymeric casings.

Yet another aspect of the present invention includes a headphone cord cover system which includes a first cord cover and a second cord cover. Each cord cover includes a base portion and an outwardly opening channel portion disposed adjacent to the base portion. The outwardly opening channel portion of each cord cover is adapted to receive a headphone cord of an existing headphone set. A first magnetic coupling element is disposed in the base portion of the first cord cover, and a second magnetic coupling element is disposed in the base portion of the second cord cover. In use, the first and second magnetic coupling elements are adapted to generate a magnetic attraction between one another to magnetically couple the first and second cord covers having the headphone cords of the existing headphone set received therein.

These and other aspects, objects, and features of the present invention will be understood and appreciated by those skilled in the art upon studying the following specification and appended drawings.

### BRIEF DESCRIPTION OF THE DRAWINGS

In the drawings:

FIG. 1 is an elevational view of a set of headphones and an associated electronic device to be used with the headphones;

FIG. 2 is an elevational view of a set of headphones;

FIG. 3 is an elevational view of a set of headphones in accordance with one embodiment of the present invention;

FIG. 4 is a perspective view of magnetic tape;

FIG. 4A is a perspective view of a headphone set according to another embodiment of the present invention;

FIGS. 5-7 are cross-sectional views of headphone cords according to embodiments of the present invention;

FIG. 5A is a top plan cross-sectional view of a pair of magnetically coupled headphone cords as shown in FIG. 5;

FIG. 6A is a cross-sectional fragmentary perspective view of magnetically coupled headphone cords shown in FIG. 6;

FIG. 7A is a top plan cross-sectional view of magnetically coupled headphone cords as shown in FIG. 7;

FIG. 8 is a fragmentary perspective view of a cord cover according to another embodiment of the present invention;

FIG. 8A is a top plan cross-sectional view of the cord cover of FIG. 8;

FIG. 9 is a top plan cross-sectional view of a cord cover according to another embodiment of the present invention; and

FIG. 9A is a top plan cross-sectional view of magnetically coupled cord covers as shown in FIG. 9.

### DETAILED DESCRIPTION OF EMBODIMENTS

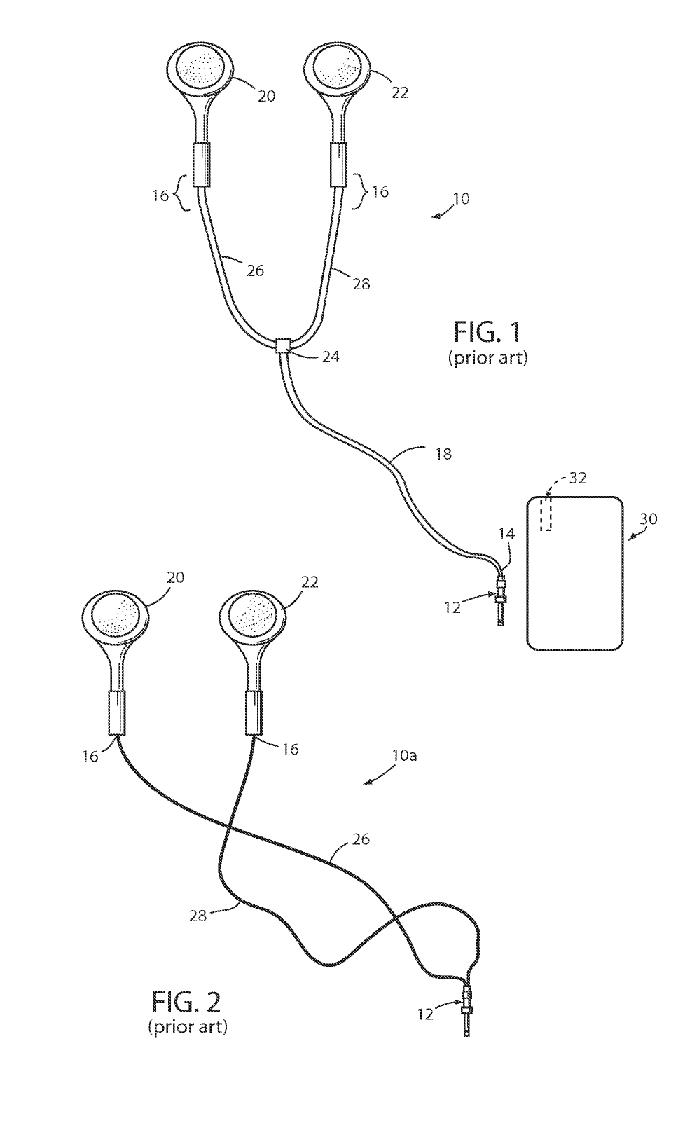

For purposes of description herein, the terms “upper,” “lower,” “right,” “left,” “rear,” “front,” “vertical,” “horizontal,” and derivatives thereof shall relate to the invention as oriented in FIG. 1. However, it is to be understood that the invention may assume various alternative orientations, except where expressly specified to the contrary. It is also to be understood that the specific devices and processes illustrated in the attached drawings, and described in the following specification are simply exemplary embodiments of the inventive concepts defined in the appended claims. Hence, specific dimensions and other physical characteristics relating to the embodiments disclosed herein are not to be considered as limiting, unless the claims expressly state otherwise.

As used throughout this disclosure, the terms “earphone” or “headphone”, or plural forms thereof, are used to identify any type of device that provides audio sound to a listener's ear, whether such device is inserted into the listener's ear or is placed adjacent to the listener's ear externally. The terms “earphone set” or “headphone set” generally indicates an apparatus having earphones as well as the associated cords used to electronically transmit sound or audio data to the earphones. A plug member is also generally included in a headphone or earphone set and is used to couple the headphone set to a jack on an electronic device.

Referring to FIG. 1, a headphone set 10 is shown which is generally Y-shaped in configuration. As shown, a male plug member 12 is coupled to a proximal end 14 of the headphone set 10, and earphone or headphone units 20, 22, which indicate left and right earphone units respectively, are connected at distal ends 16 of the headphone set 10. The headphone set 10 includes cords such as a unitary lead cord 18 which extends from the male plug 12 to a collar 24 from which two branched cords 26, 28 extend into left and right cords 26, 28. The left and right cords 26, 28 terminate in the earphones 20, 22, respectively, which give the headphone set 10 an overall y-shaped configuration. As shown in FIG. 1, an electronic device 30 comprises a female socket or jack 32 which couples to the male plug 12 of the headphone set 10 for transmission of electronic sound data from the electronic device 30 to the earphones 20, 22. The headphone set 10, as shown in FIG. 1, is known in the art and susceptible to entanglements between the lead cord 18 and the right and left cords 26, 28. As shown in FIG. 2, another embodiment of headphone set 10a is shown having a male plug 12 along with left and right cords 26, 28 which terminate at distal ends 16 at earphones 20, 22, respectively. In this embodiment, the headphone set 10a does not include a lead cord or a collar, but rather has freely branched left and right cords 28, 26 that extend from the male plug 12 directly to the earphones 20, 22. The cords 28, 26 in this embodiment are also susceptible to entanglement in use.

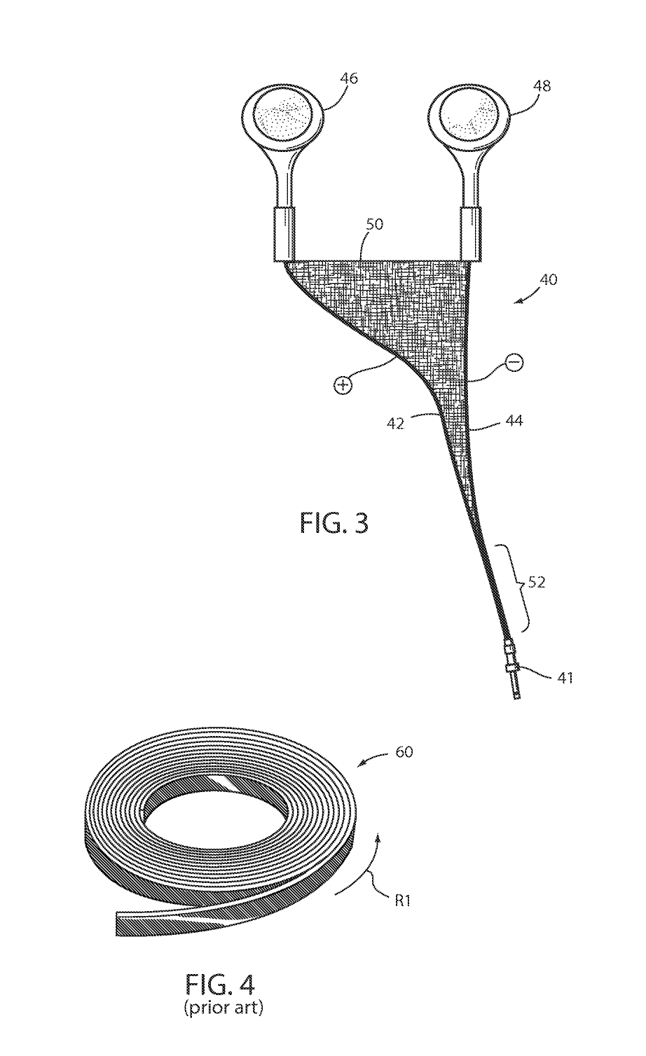

Referring now to FIG. 3, an embodiment of the present invention is shown as incorporated into a headphone set 40 which is similar to the headphone set 10a shown in FIG. 2, however, the headphone set 40, as shown in FIG. 3, has left and right cords 42, 44 that extend from a male plug 41 at a proximal end and terminate at left and right earphone or headphone units 46, 48 at a distal end. The headphone set 40, as shown in FIG. 3, further comprises a magnetic field or area of magnetic attraction 50 disposed between the left and right earphone cords 42, 44 as created by magnets embedded within the left and right earphone cords 42, 44 as further described below. As shown in FIG. 3, the left earphone cord 42 has a positive magnetic polarity indicated, whereas earphone cord 44 has a negative magnetic polarity indicated, such that left and right earphone cords 42, 44 have opposite poles and are attracted to one another, thereby creating the magnetic field 50. Further, cords 42, 44 are partially magnetically coupled to one another in an engaged position as indicated by reference number 52. In the area extending from area 52 to the headphone units 46, 48, the cords 42, 44 are in an unengaged or separated position.

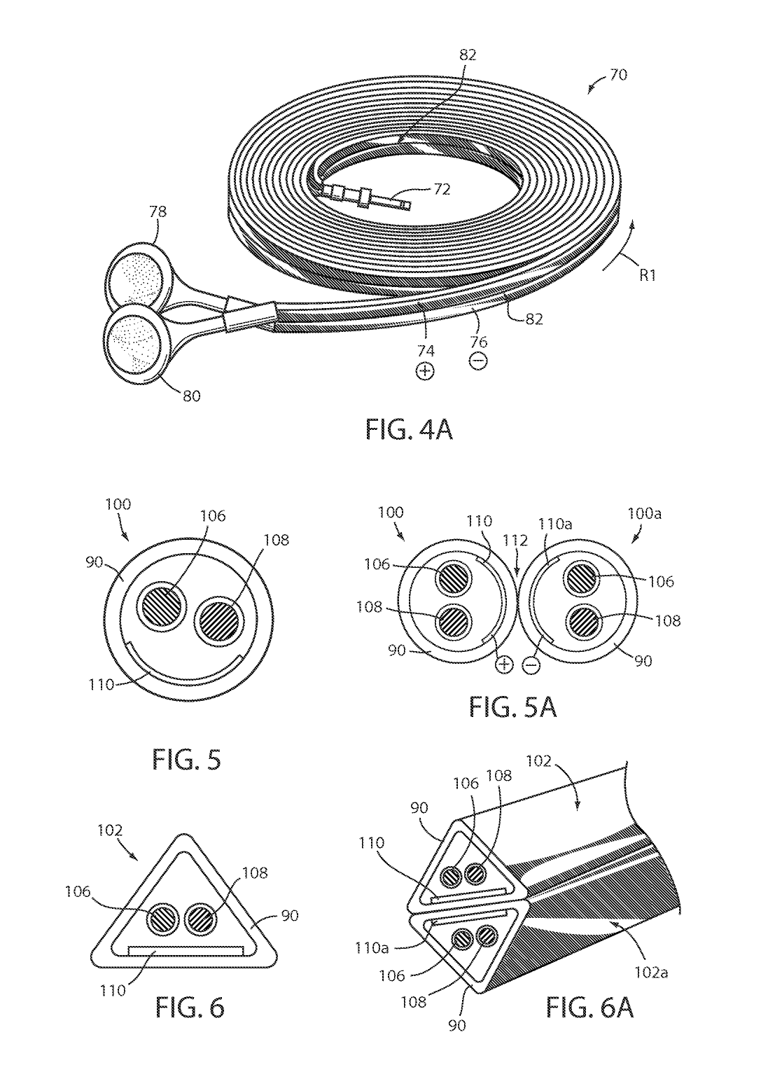

Referring now to FIG. 4, a coiled strip of magnetic tape 60 is shown which has a torsional bias or coiling condition integrated therein as indicated by arrow R₁, such that the magnetic tape 60 is biased towards a coiled condition as indicated in FIG. 4. The magnetic tape 60, as shown in FIG. 4, is a flexible magnetic tape having magnetic particles such as strontium or barium ferrite embedded within a polymeric matrix that makes up the magnetic tape 60.

FIG. 4A indicates a headphone set 70 having a male plug 72 connected to left and right earphone cords 74, 76, which terminate in earphone units 78 and 80 respectively. The headphone set 70 as shown in FIG. 4A is contemplated to have a magnetic tape, such as magnetic tape 60 shown in FIG. 4, incorporated into the left and right earphone cords 74, 76, such that the earphone cords 74, 76 are operably coupled to one another at a magnetic coupling line 82. In this way, the left and right earphone cords 74, 76 are neatly coupled in the engaged position from the male plug 72 to the earphones 78, 80 and can be separated by the user as needed along any length of the cords 74, 76. Further, the headphone set 70 shown in FIG. 4A has retained the torsional bias of the magnetic tape 60, shown in FIG. 4, as indicated by arrow R₁, such that the headphone set 70, when not in use, neatly coils in the configuration as shown in FIG. 4A.

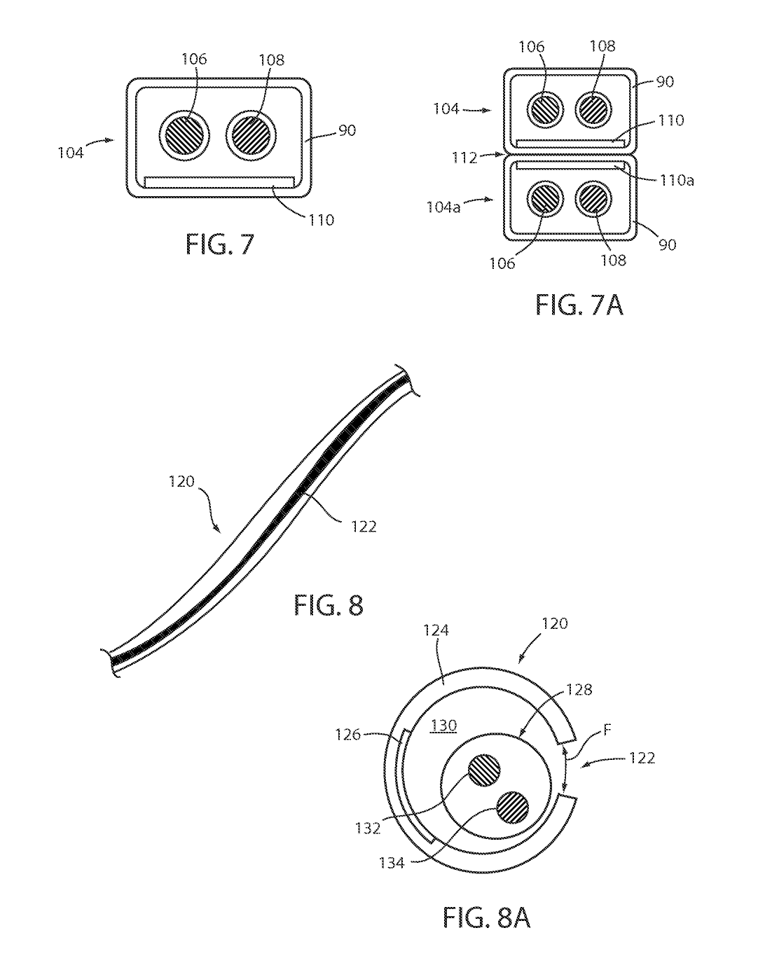

Referring now to FIGS. 5-7, cross-sectional views of cords suitable for use as the left or right cords in a headphone set are shown. In the embodiments shown in FIGS. 5-7, the headphone cords comprise an insulation or outer casing layer wrapped around an outer circumference of the cords, wherein the insulation is generally a polymeric casing or cover indicated as reference numeral 90. The configurations shown in FIGS. 5, 6, and 7 are generally circular, triangular, and rectangular, respectively, and are indicated with reference numerals 100, 102, and 104. Encased within the insulation 90 are low voltage electrical wires such as tinsel wire used to transmit sound from a portable electronic device to a set of earphones, such as earphones 78, 80 as shown in FIG. 4A. The electrical wires shown in FIGS. 5-7 are indicated as reference numerals 106, 108, and are flexible wires known in the art for use in transmission of electrical sound or audio data to earphones and headsets. Disposed along an edge of the cords 100, 102, and 104 are magnet coupling elements or members 110, 110a which are disposed adjacent the insulation 90. The magnet coupling elements 110, 110a are used to couple one cord 100 to another 100a by creating a magnetic attraction or magnetic field between adjacent cords 100, 100a (FIG. 5A), such that the cords 100, 100a magnetically couple to one another in an engaged position to prevent tangling of the cords 100, 100a in use.

As shown in FIGS. 5A-7A, the cords 100, 102, and 104 are shown coupled to reciprocal cords 100a, 102a, and 104a by a magnetic coupling made possible by the magnets 110 and 110a disposed in the reciprocal cord pairs. For example, as shown in FIG. 5A, cord 100 is magnetically coupled to cord 100a at a coupling point 112 due to the magnetic force of magnetic coupling element 110, which has a positive polarity, and magnetic coupling element 110a, which has a negative or opposite magnetic polarity. Therefore, cord 100 is magnetically coupled to cord 100a by the magnetic force or attraction created between magnetic coupling elements 110 and 110a. The magnetic coupling elements 110 and 110a are concealed within and disposed at an appropriate distance within the insulation 90, such that the magnet coupling elements 110 and 110a have sufficient magnetic power to couple the cords 100, 100a at coupling point 112 through the polymeric insulation 90. In this way, the cord pairs 100, 100a; 102, 102a; and 104, 104a as shown in FIGS. 5A-7A, remain magnetically coupled and untangled when in use by a listener. Further, the portions of the cord pairs which remain in excess can be coiled in a configuration such as that shown in FIG. 4A when a full cord extension is not needed to extend from the electronic portable device to the ears of the listener.

While the cord pairs as shown in FIGS. 5A-7A are magnetically coupled to one another in an engaged condition, it is contemplated that the cord pairs are easily separated by a user pulling on the left and right cords to separate the magnetic connection between the cords along the magnetic coupling line 112 as the cords are separated from an engaged or magnetically coupled condition. In this way, the user can easily separate the cord pairs as needed by applying a force necessary to overcome the magnetic attraction between the magnetic coupling elements. It is noted further that the cord configurations shown in FIGS. 5-7 are exemplary only, and any cord configuration is contemplated for use with the present invention, wherein a magnetic coupling element can be disposed adjacent a cord insulation, such that one cord can magnetically couple to another. Further, it is contemplated that where strong magnetic connection is desired, the magnetic element can be exposed through the insulation for operably coupling directly to a reciprocal magnet. For ease of identification, the embodiments shown in FIGS. 5-7 and 5A-7A indicate a fair amount of free space between the magnets 110 and the wires 106, 108, however, it is contemplated that these components can be tightly grouped within the insulation 90 such that the resulting cord, having a magnetic member disposed therein, appears similar in size to a standard headphone cord. Further, it is contemplated that magnetic members 110, 100a (FIG. 5A) run the entire length of cords 100, 100a, thereby allowing for magnetic coupling of the cords 100, 100a along full length thereof.

The magnet coupling elements 100, 100a, as shown in FIG. 5A, are contemplated to be comprised of a permanent magnet material, such as a rare-earth/cobalt material, or a ferrite ceramic material, or the like. The magnet coupling elements 100, 100a, may also be a combination of materials, such as element 100 being comprised of a permanent magnet material, while element 100a may be comprised of a magnetic attracting component such as iron or steel or alloys thereof. Further, the magnet coupling elements 100, 100a, may also be a combination of materials where element 100 is comprised of a magnetizable material which is constituted in part from non-ferromagnetic materials. So long as the magnet coupling elements 110, 110a have sufficient magnetic power or attraction to couple the cords 100, 100a to an engaged position, they are suitable for use with the present invention.

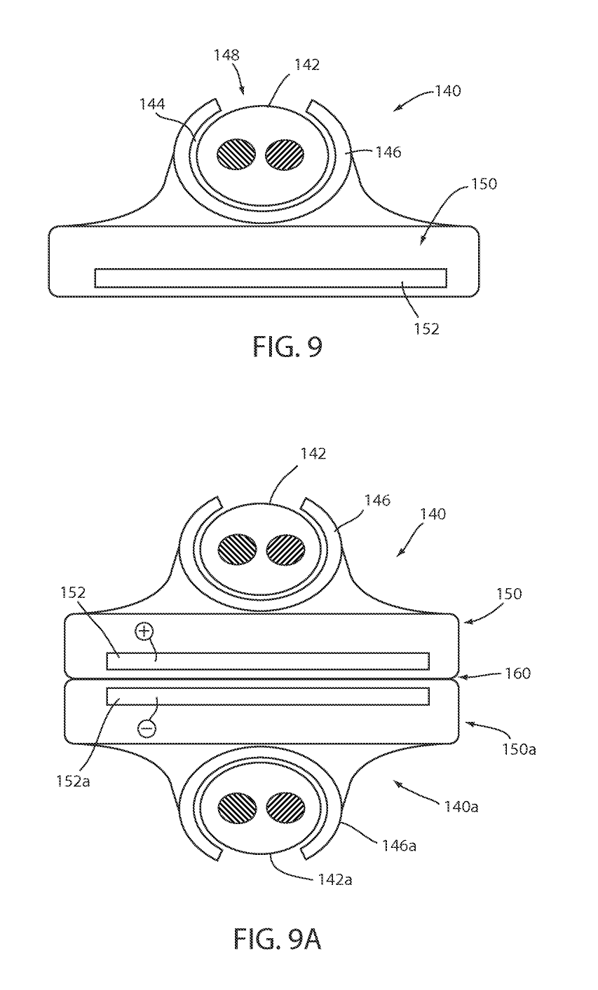

In another embodiment of the present invention shown in FIG. 8, a cord cover or sheath 120 is shown having a channel 122. As shown in FIG. 8A, the cord cover 120 is comprised of a polymeric exterior shell 124 which, in FIG. 8A, has a generally c-shaped configuration. Within the flexible polymeric shell 124, a magnetic member 126 is disposed at a position along the polymeric shell 124 such that the magnet 126 can couple to a reciprocal magnet of another cord cover in use. In the embodiment shown in FIGS. 8 and 8A, it is contemplated that a headphone cord, such as headphone cord 128 shown in FIG. 8A, can be pressed into the channel 122 such that the cord 128 is disposed within an interior 130 of the cord cover 120. As shown in FIG. 8A, the headphone cord 128 comprises wires 132, 134 which are used to transmit sound data to earphones in application. The embodiment shown in FIGS. 8 and 8A is designed to work with a user's existing headphone set, such as headphone set 10 shown in FIG. 1, and it is contemplated that the cord cover 120 can be trimmed to fit the amount of free cord in a user's present headphone set that is susceptible to entanglement. Thus, the embodiment shown in FIGS. 8 and 8A provides the listener with a custom fit cord cover that can magnetically couple free cords of the listener's existing headphone set using the cord cover 120. While the embodiment in FIG. 8A shows the cord 128 disposed freely within an interior 130 of the cord cover 120, it is contemplated that the interior 130 of the cord cover 120 can be configured to closely match the shape of the cords to be disposed therein, such that a frictional fit exists between the cord and the cord cover as better shown in the embodiments depicted in FIGS. 9 and 9A. In retrofitting a user's existing headphone set with the cord cover 120 of FIGS. 8 and 8A, the cord, such as cord 128 shown in FIG. 8A, will be pushed into the channel 122 which can flex as indicated by arrow F to accommodate the size of the cord 128 for entry of the cord 128 into the interior 130 of the cord cover 120. As noted above, the cord cover 120 has a polymeric exterior 124 which is contemplated to be a resilient and flexible exterior such that the channel 122 will resiliently close or reassume an at-rest shape to encapsulate the cord 128 once disposed within the interior 130 of the cord cover 120.

In the embodiment shown in FIGS. 9 and 9A, a cord cover 140 is shown having a cord 142 disposed within an interior 144 of a c-shaped engagement member 146. The c-shaped engagement member 146 is shown in FIGS. 9 and 9A as an outwardly opening channel disposed adjacent to the base portion 150, and is further contemplated to be made of a polymeric material which is flexible and resilient such that the cord 142 can be pressed into a flexibly opening channel 148 of the c-shaped engagement member 146 and then be positively engaged or captured within the arms defining the interior 144 of the c-shaped engagement member 146. The cord cover 140, as shown in FIG. 9, further comprises a planar surface on the base member 150 with a magnet 152 disposed adjacent thereto.

As shown in FIG. 9A, cord cover 140 is magnetically coupled to cord cover 140a, wherein cords 142 and 142a are positively retained in c-shaped engagement members 146 and 146a of the pair of cord covers 140, 140a. The cord covers 140, 140a are magnetically coupled by the force created between positive magnet 152 and negative magnet 152a along a flat planar surface of base portion 150 and 150a at an abutment or coupling line 160. In this way, the embodiments shown in FIGS. 9 and 9A provides for large magnetic member 152, 152a to be disposed in base portions 150, 150a for a substantial coupling at abutment line 160 between the cord covers 140, 140a. The cord covers 140, 140a are designed to work in a similar manner as the cord covers 120 depicted in the embodiments shown in FIGS. 8 and 8A such that cord covers 140, 140a can also be customized to be used with a user's existing headphone set.

It is noted that the magnets as used and described herein are positioned to be effective couplers of reciprocal magnets in use, however, it is further noted that the magnets are designed to not disrupt the transmission of electrical sound data from an electronic device to an earphone unit.

It will be understood by one having ordinary skill in the art that construction of the described invention and other components is not limited to any specific material. Other exemplary embodiments of the invention disclosed herein may be formed from a wide variety of materials, unless described otherwise herein.

For purposes of this disclosure, the term “coupled” (in all of its forms, couple, coupling, coupled, etc.) generally means the joining of two components directly or indirectly to one another. Such joining may be stationary in nature or movable in nature. Such joining may be achieved with the two components and any additional intermediate members being integrally formed as a single unitary body with one another or with the two components. Such joining may be permanent in nature or may be removable or releasable in nature unless otherwise stated.

It is also important to note that the construction and arrangement of the elements of the invention as shown in the exemplary embodiments is illustrative only. Although only a few embodiments of the present innovations have been described in detail in this disclosure, those skilled in the art who review this disclosure will readily appreciate that many modifications are possible (e.g., variations in sizes, dimensions, structures, shapes and proportions of the various elements, values of parameters, mounting arrangements, use of materials, colors, orientations, etc.) without materially departing from the novel teachings and advantages of the subject matter recited. Accordingly, all such modifications are intended to be included within the scope of the present innovations. Other substitutions, modifications, changes, and omissions may be made in the design, operating conditions, and arrangement of the desired embodiment and other exemplary embodiments without departing from the spirit of the present innovations.

What is claimed is:

1. A headphone set, comprising:
a pair of headphone units including a left headphone unit and a right headphone unit;
a first cord operably coupled to the left headphone unit at a distal end, and further coupled to a plug member at a proximal end;
a second cord operably coupled to the right headphone unit at a distal end; and further coupled to the plug member at a proximal end;
a first magnetic coupling element disposed along a length of the first cord;
a second magnetic coupling element disposed along a length of the second cord; and
wherein the first and second cords are operable between an engaged position and an unengaged position, and further wherein the first and second magnetic coupling elements comprise a magnetic attraction between one another and are adapted to magnetically couple the first and second cords along a length thereof in the engaged position.

2. The headphone set of claim 1, wherein:
one of the first and second magnetic coupling elements comprises a permanent magnet, and further wherein the other one of the first and second magnetic coupling elements comprises a magnetic attracting component.

3. The headphone set of claim 2, wherein:
wherein a force required to separate the first and second cords from the engaged position to the unengaged position is limited to the force required to overcome the magnetic attraction between the first and second magnetic coupling elements.

4. The headphone set of claim 3, including:
polymeric casings disposed about the first and second cords and concealing the first and second magnetic coupling elements therein; and
wherein the magnetic attraction between the first and second magnetic coupling elements is sufficient to magnetically couple the first and second cords through the polymeric casings.

5. The headphone set of claim 4, including:
a unitary cord portion and a branched cord portion, wherein the first and second cords are mechanically coupled along the unitary cord portion and adapted to be magnetically coupled along the branched cord portion.

6. The headphone set of claim 5, including:
a collar member disposed between the unitary cord portion and the branched cord portion.

7. The headphone set of claim 1, including:
a torsional bias disposed in the first and second cords, wherein the torsional bias is adapted to coil the first and second cords in the engaged position.

8. A headphone set, comprising:
first and second cord assemblies, each cord assembly including an outer polymeric casing;
electrical wires disposed within the outer polymeric casing of each cord assembly, wherein the electrical wires are adapted to electrically deliver audio data to headphone units associated with each cord assembly;
a first magnetic coupling element disposed along a length of the first cord assembly;
a second magnetic coupling element disposed along a length of the second cord assembly; and
wherein the first and second magnetic coupling elements are adapted to generate a magnetic attraction between one another to magnetically couple the first and second cord assemblies through the polymeric casings.

9. The headphone set of claim 8, wherein:
one of the first and second magnetic coupling elements comprises a permanent magnet, and further wherein the other one of the first and second magnetic coupling elements comprises a magnetic attracting component.

10. The headphone set of claim 9, wherein:
a force required to separate the first and second cord assemblies from a magnetically coupled condition to a separated condition is limited to the force required to overcome the magnetic attraction between the first and second magnetic coupling elements.

11. The headphone set of claim 8, wherein:
one of the first and second magnetic coupling elements comprises a flexible magnetic tape, and further wherein the other one of the first and second magnetic coupling elements comprises a magnetic attracting component.

12. The headphone set of claim 8, wherein:
the first and second magnetic coupling elements comprises a flexible magnetic tape, and further wherein the flexible magnetic tape includes a torsional bias adapted to coil the first and second cord assemblies.

13. A headphone cord cover system, comprising:
a first cord cover including a base portion and an outwardly opening channel portion disposed adjacent to the base portion, wherein the outwardly opening channel portion is adapted to receive a first headphone cord;
a second cord cover including a base portion and an outwardly opening channel portion disposed adjacent to the base portion, wherein the outwardly opening channel portion is adapted to receive a second headphone cord;
a first magnetic coupling element disposed in the base portion of the first cord cover;
a second magnetic coupling element disposed in the base portion of the second cord cover;
wherein the first and second magnetic coupling elements are adapted to generate a magnetic attraction between one another to magnetically couple the first and second cord covers.

14. The headphone set of claim 13, wherein:
one of the first and second magnetic coupling elements comprises a permanent magnet, and further wherein the other one of the first and second magnetic coupling elements comprises a magnetic attracting component.

15. The headphone set of claim 14, wherein:
a force required to separate the first and second cord covers from a magnetically coupled condition to a separated condition is limited to the force required to overcome the magnetic attraction between the first and second magnetic coupling elements.

16. The headphone set of claim 15, wherein:
the outwardly opening channel portions of the first and second cord covers includes flexibly resilient arms adapted to engage the headphone cords.

17. The headphone set of claim 13, wherein:
one of the first and second magnetic coupling elements comprises a magnetized material, and further wherein the other one of the first and second magnetic coupling elements comprises a magnetic attracting component.
